(19) United States
(12) Patent Application Publication
(10) Pub. No.: US 2026/0171325 A1
(43) Pub. Date: Jun. 18, 2026

(54) TANTALUM CAPACITOR

(71) Applicant: SAMSUNG ELECTRO-MECHANICS CO., LTD., Suwon-si (KR)

(72) Inventors: Jinyoung Kim, Suwon-si (KR); Boumseock Kim, Suwon-si (KR); Chin Mo Kim, Suwon-si (KR); Myung Jin Jung, Suwon-si (KR); Sangmoon Lee, Suwon-si (KR)

(73) Assignee: SAMSUNG ELECTRO-MECHANICS CO., LTD., Suwon-si (KR)

(21) Appl. No.: 19/266,312

(22) Filed: Jul. 11, 2025

(30) Foreign Application Priority Data
Dec. 16, 2024 (KR) 10-2024-0187120

(51) Int. Cl. H01G 9/012; H01G 9/00; H01G 9/042

(52) U.S. Cl. CPC H01G 9/012; H01G 9/0029; H01G 9/042

(57) ABSTRACT

An embodiment of the present disclosure provides a tantalum capacitor including: a capacitor body including a tantalum body, a tantalum wire connected to the tantalum body, and a capsule portion surrounding the tantalum body and the tantalum wire; and an external electrode positioned outside the capacitor body, wherein at least one of a region between the tantalum wire and the capsule portion and a region between the external electrode and the capsule portion includes an interfacial compound including at least one selected from the group consisting of a compound including a C—H bond and a Si—C bond, a compound including a Si—O—Si bond, and a compound including a C—O bond.

### CROSS-REFERENCE TO RELATED APPLICATION

This application claims priority to and the benefit of Korean Patent Application No. 10-2024-0187120 filed with the Korean Intellectual Property Office on Dec. 16, 2024, the entire contents of which are incorporated herein by reference.

### BACKGROUND OF THE INVENTION

### (a) Field of the Invention

The present disclosure relates to a tantalum capacitor.

### (b) Description of the Related Art

Tantalum capacitors are electronic components used in various passive component-intensive products, such as TVs, mobile devices, laptop computers, tablet computers, digital cameras, medical devices, and automotive electrical components.

Tantalum (Ta) materials are widely used throughout industries, including electrical, electronic, mechanical, and chemical engineering, as well as aerospace and military fields, due to their high melting point and excellent mechanical or physical properties such as ductility and corrosion resistance. These tantalum materials are widely used as positive electrode materials for small capacitors due to their properties that may form a stable positive electrode oxide film, and their usage has been rapidly increasing every year due to the rapid development of IT industries such as electronics and information and communication.

Recently, as electronic products have become more dense and thinner, the operating reliability and stability of tantalum capacitors need to be improved.

### SUMMARY OF THE INVENTION

According to an aspect of the present disclosure, a tantalum capacitor with improved reliability and stability may be provided.

However, the problems to be solved by embodiments are not limited to the above-described problem and may be variously extended in a range of technical ideas included in embodiments.

An embodiment provides a tantalum capacitor including: a capacitor body including a tantalum body, a tantalum wire connected to the tantalum body, and a capsule portion surrounding the tantalum body and the tantalum wire; and an external electrode positioned outside the capacitor body. At least one of a region between the tantalum wire and the capsule portion and a region between the external electrode and the capsule portion includes an interfacial compound including at least one selected from the group consisting of a compound including a C—H bond and a Si—C bond, a compound including a Si—O—Si bond, and a compound including a C—O bond.

The capacitor body may further include a substrate layer positioned below the capsule portion, and a lower electrode positioned between the substrate layer and the tantalum body.

A region between the lower electrode and the substrate layer may include the interfacial compound.

The capacitor body may further include a conductive bonding layer between the tantalum body and the external electrode and between the tantalum body and the lower electrode.

The compound including the C—H bond and the Si—C bond may be derived from an aminosilane-based compound.

The compound including the Si—O—Si bond may be derived from a silicon-based compound.

The compound including the C—O bond may be derived from an epoxy-based compound.

The capacitor body may have first and second surfaces facing in a first direction, third and fourth surfaces facing in a second direction and connecting the first and second surfaces, and fifth and sixth surfaces facing in a third direction and connecting the first and second surfaces, and the external electrode may include a first external electrode and a second external electrode respectively positioned on the first surface and the second surface.

The first external electrode may be connected to the tantalum wire.

The capacitor body may further includes a substrate layer positioned below the capsule portion, and a lower electrode positioned between the substrate layer and the tantalum body, and the second external electrode may be connected to the lower electrode.

The first external electrode may cover the first surface and at least a portion of the sixth surface together, and the second external electrode may cover the second surface and at least a portion of the sixth surface together.

The capsule portion may include an epoxy resin.

Another embodiment provides a method for manufacturing a tantalum capacitor, including: preparing a pre-tantalum capacitor including a capacitor body and an external electrode positioned on a first surface of the capacitor body; and manufacturing a tantalum capacitor by vacuum impregnating the pre-tantalum capacitor into at least one selected from the group consisting of an aminosilane-based compound, a silicone-based compound, and an epoxy-based compound. At least one of a region between the tantalum wire and the capsule portion and a region between the external electrode and the capsule portion includes an interfacial compound including at least one selected from the group consisting of a compound including a C—H bond and a Si—C bond, a compound including a Si—O—Si bond, and a compound including a C—O bond.

According to the embodiment of the present disclosure, moisture penetration between respective components of the tantalum capacitor may be suppressed, thereby improving reliability and stability.

According to the embodiment, moisture penetration into the micro-space of the tantalum capacitor may be suppressed, thereby suppressing corrosion, peeling, and open defects of metal components.

### BRIEF DESCRIPTION OF THE DRAWINGS

FIG. 1 conceptually illustrates a transparent perspective view of a tantalum capacitor according to an embodiment.

FIG. 2 illustrates a cross-sectional view of a tantalum capacitor according to an embodiment taken along line I-I′ of FIG. 1.

FIG. 3 illustrates a cross-sectional other of a tantalum capacitor according to another embodiment taken along line I-I′ of FIG. 1.

FIG. 4, FIG. 6, and FIG. 7 illustrate Fourier transform infrared (FT-IR) analysis graphs of the tantalum capacitor of Example 1 to Example 3 and a comparative example.

FIG. 5 illustrates a Raman spectrum analysis graph of Example 2.

FIG. 8 illustrates a graph of results of a high-acceleration stress test of each of tantalum capacitors of Example 1 and a comparative example.

### DETAILED DESCRIPTION OF THE EMBODIMENTS

The present disclosure will be described more fully hereinafter with reference to the accompanying drawings, in which embodiments of the disclosure are shown. The drawings and description are to be regarded as illustrative in nature and not restrictive. Like reference numerals designate like elements throughout the specification. In addition, some constituent elements are exaggerated, omitted, or briefly illustrated in the added drawings, and sizes of the respective constituent elements do not reflect the actual sizes.

The accompanying drawings are provided only in order to allow embodiments disclosed in the present specification to be easily understood and are not to be interpreted as limiting the spirit disclosed in the present specification, and it is to be understood that the present disclosure includes all modifications, equivalents, and substitutions without departing from the scope and spirit of the present disclosure.

Terms including an ordinal number, such as first, second, etc., may be used to describe various elements, but the elements are not limited by the terms. These terms are only used to differentiate one constituent element from another.

It should be understood that when an element such as a layer, film, region, area or substrate is referred to as being “on” another element, it can be directly on the other element or intervening elements may also be present. In contrast, when an element is referred to as being “directly on” another element, there are no intervening elements present. Further, in the specification, the word “on” or “above” means disposed on or below the object portion, and does not necessarily mean disposed on the upper side of the object portion based on a gravitational direction.

Throughout the specification, it should be understood that the term “include”, “comprise”, “have”, or “configure” indicates that a feature, a number, a step, an operation, a constituent element, a part, or a combination thereof described in the specification is present, but does not exclude a possibility of presence or addition of one or more other features, numbers, steps, operations, constituent elements, parts, or combinations, in advance. Unless explicitly described to the contrary, the word “comprise” and variations such as “comprises” or “comprising” will be understood to imply the inclusion of stated elements but not the exclusion of any other elements.

Further, throughout the specification, the phrase “in a plan view” or “on a plane” means viewing a target portion from the top, and the phrase “in a cross-sectional view” or “on a cross-section” means viewing a cross-section formed by vertically cutting a target portion from the side.

Furthermore, throughout the specification, “connected” does not only mean when two or more elements are directly connected, but also when two or more elements are indirectly connected through other elements, and when they are physically connected or electrically connected, and further, it may be referred to by different names depending on a position or function, and may also be referred to as a case in which respective parts that are substantially integrated are linked to each other.

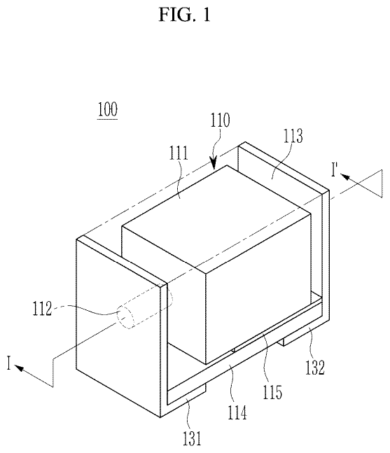

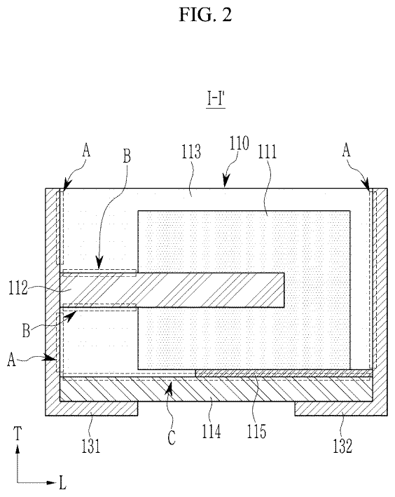

FIG. 1 conceptually illustrates a transparent perspective view of a tantalum capacitor according to an embodiment. FIG. 2 illustrates a cross-sectional view of a tantalum capacitor according to an embodiment taken along line I-I′ of FIG. 1.

The L-axis, W-axis, and T-axis shown in the drawings represent a length direction, a width direction, and a thickness direction of a tantalum capacitor 100 and a capacitor body 110, respectively.

The length direction (L-axis direction) may be a direction that is substantially perpendicular to the thickness direction (T-axis direction). For example, the length direction (L-axis direction) may represent a direction in which a tantalum wire 112 extends. The width direction (W-axis direction) may be a direction that is substantially perpendicular to the thickness direction (T-axis direction) and the length direction (L-axis direction). The length of the tantalum capacitor 100 or the capacitor body 110 in the length direction (L-axis direction) may be greater than the length in the width direction (W-axis direction).

Hereinafter, for better comprehension and ease of description, in the capacitor body 110, both surfaces facing in the first direction are defined as first and second surfaces, both surfaces connected to the first and second surfaces and facing in the second direction are defined as third and fourth surfaces, and both surfaces connected to the first and second surfaces and connected to the third and fourth surfaces and facing in the third direction are defined as fifth and sixth surfaces.

In the present specification, the first direction and the above-described length direction (L-axis direction) may be used with the same meaning, the second direction and the above-described width direction (W-axis direction) may be used with the same meaning, and the third direction and the above-described stacking direction (T-axis direction) may be used with the same meaning.

Referring to FIG. 1 and FIG. 2, the tantalum capacitor 100 according to the embodiment may include the capacitor body 110.

The capacitor body 110 may include a tantalum body 111 and a tantalum wire 112 connected to the tantalum body 111.

The shape of the tantalum body 111 may include a pellet, a sponge, a sheet, a foil, a mesh, or the like.

The tantalum body 111 may be formed using tantalum (Ta) metal or tantalum powder.

The tantalum powder may be manufactured by reacting a tantalum salt such as potassium fluorotantalate (K₂TaF₇), sodium fluorotantalate (Na₂TaF₇), or tantalum pentachloride (TaCl₅) with a reducing agent. These may be used alone or in combination of two or more.

The tantalum powder and a binder may be mixed in a predetermined ratio. The mixed powder may be compressed to be molded into a rectangular parallelepiped or other suitable shape. The molded body may be sintered under high temperature and high vacuum conditions to manufacture the tantalum body 111.

According to the embodiment, the tantalum wire 112 may be inserted into the tantalum body 111 to protrude from one side surface. The tantalum wire 112 may be extended to contact a first surface of the capacitor body 110.

When manufacturing the above-described tantalum body 111, a portion of the tantalum wire 112 may be inserted into a mixture of tantalum powder and binder in the length direction (L-axis direction), and then molded and sintered together with the tantalum wire 112 and the tantalum body 111. For example, the tantalum wire 112 may be inserted so as to be positioned at the center in the thickness direction (T-axis direction) of the tantalum body 111.

The tantalum wire 112 may be a tantalum metal rod having a rod shape, a bar shape, or the like. For example, the tantalum wire 112 may be provided as an anode of a tantalum capacitor.

A dielectric layer (not shown) may be disposed on the surface of the tantalum body 111. The dielectric layer may be formed through anodization of a tantalum capacitor. For example, the dielectric layer may include an oxide of tantalum metal, for example, tantalum pentoxide (Ta₂O₅) or the like.

For example, the capacitor body 110 may further include a solid electrolyte layer (not shown) disposed on the surface of the tantalum body 111.

The solid electrolyte layer may be disposed on the surface of the dielectric layer by immersing the tantalum body 111 on which the dielectric layer is disposed in a polymerization solution and reacting it in a polymerization furnace. The solid electrolyte layer may be provided as a cathode of the tantalum capacitor. Therefore, the tantalum body 111 may be provided as a cathode of the tantalum capacitor.

The solid electrolyte layer may include a conductive polymer, manganese dioxide (MnO₂), or a combination thereof.

When the solid electrolyte layer includes a conductive polymer, it may be formed on the surface of the dielectric layer by chemical polymerization or electrolytic polymerization. The conductive polymer material is not particularly limited as long as it is a polymer material with conductivity, and may include, for example, polypyrrole, polythiophene, polyacetylene, and/or polyaniline.

When the solid electrolyte layer includes manganese dioxide (MnO₂), the tantalum body 111 may be immersed in a manganese aqueous solution such as manganese nitrate, and then the manganese aqueous solution may be thermally decomposed to form conductive manganese dioxide on the surface of the dielectric layer.

For example, the solid electrolyte layer may include an acid such as para toluenesulfonic acid (P-TSA).

According to the acid component, the solid electrolyte layer may be combined with moisture under the load condition of high temperature and high humidity, thereby causing corrosion of the internal metal. However, according to the embodiment of the present disclosure, moisture penetration between respective components of the tantalum capacitor 100 may be suppressed, thereby improving reliability and stability.

The capacitor body 110 may further include a cathode reinforcing layer (not shown) disposed on the surface of the tantalum body 111 or the solid electrolyte layer. The cathode reinforcing layer may include a carbon layer and a silver (Ag) layer. For example, the carbon layer and the silver layer may be sequentially stacked on the solid electrolyte layer. Contact resistance of the surface of the tantalum body 111 may be reduced through the carbon layer. Electrical conductivity of the tantalum capacitor 100 may be improved through the silver layer.

The solid electrolyte layer and the cathode reinforcing layer may be insulated from the tantalum wire 112. Accordingly, the cathode and the anode of the tantalum capacitor 100 are insulated from each other, thereby preventing a short circuit.

In some embodiments, the capacitor body 110 may further include a capsule portion 113 accommodating the tantalum body 111 and the tantalum wire 112.

The capsule portion 113 may surround the tantalum body 111 and the tantalum wire 112. Accordingly, the tantalum body 111 and the tantalum wire 112 may be protected from external impact or contamination.

The capsule portion 113 may include an epoxy resin. For example, the capsule portion 113 may include a photocurable epoxy resin surrounding the capacitor body 110. For example, the epoxy resin may include an epoxy molding compound (EMC) or the like. For example, the capsule portion 113 may be formed using transfer molding, vacuum molding, compression molding, or the like of the epoxy resin.

The tantalum capacitor 100 may include external electrodes 131 and 132 positioned outside the capacitor body 110.

The external electrodes 131 and 132 may include a first external electrode 131 positioned on a first surface of the capacitor body 110 and a second external electrode 132 positioned on a second surface of the capacitor body 110, opposing the first surface.

The first external electrode 131 may be connected to the tantalum wire 112. For example, the first external electrode 131 may be positioned on the first surface to contact the tantalum wire 112 exposed to the first surface of the capacitor body 110. At least a portion of the first external electrode 131 may be provided as an anode terminal of the tantalum capacitor 100.

The second external electrode 132 may be electrically connected to the solid electrolyte layer and/or the cathode reinforcing layer disposed on the surface of the tantalum body 111 through a lower electrode 115 and/or a conductive bonding layer 116 to be described later. For example, the second external electrode 132 may be positioned on the second surface to contact the lower electrode 115 and/or the conductive bonding layer 116 contacting the second surface of the capacitor body 110. At least a portion of the second external electrode 132 may be provided as a cathode terminal of the tantalum capacitor 100.

The first external electrode 131 may cover the first surface of the capacitor body 110 and at least a portion of the sixth surface thereof, and the second external electrode 132 may cover the second surface thereof and at least a portion of the sixth surface thereof. A portion of the first external electrode 131 positioned on the sixth surface and a portion of the second external electrode 132 positioned on the sixth surface may be spaced apart from each other in the length direction (L-axis direction) to be provided to an anode terminal and a cathode terminal, respectively.

The external electrodes 131 and 132 may include Ta, W, Ni, Cr, an alloy thereof, or a mixture thereof. These may be used alone or in combination of two or more.

The external electrodes 131 and 132 may be formed on the capacitor body 110 through sputtering, but are not limited thereto.

Since the tantalum capacitor 100 does not include a separate connection frame and the external electrodes 131 and 132 are provided as terminals, the space efficiency of the tantalum capacitor 100 may be improved. In addition, the size of the tantalum body 111 and the tantalum wire 112 may increase, thereby further improving capacity characteristics and low resistance characteristics.

The tantalum capacitor 100 according to the embodiment of the present disclosure may further include an interfacial compound positioned in at least one of a region between the tantalum wire 112 and the capsule portion 113 (region B of FIG. 2) and a region between the external electrodes 131 and 132 and the capsule portion 113 (region A of FIG. 2). The interfacial compound may include at least one selected from the group consisting of a compound including a C—H bond and a Si—C bond, a compound including a Si—O—Si bond, and a compound including a C—O bond. Through the interfacial compound, moisture penetration into the microspace of the tantalum capacitor 100 may be suppressed, thereby suppressing corrosion, peeling, and open defects of the metal component.

In the context of the present disclosure, the phrase “between X and Y” may indicate a microspace that is in contact with the interface between X and Y, or a microspace between adjacent surfaces of X and Y.

The compound including the C—H bond and the Si—C bond may be derived from an aminosilane-based compound. The compound including the Si—O—Si bond may be derived from a silicone-based compound. The compound including the C—O bond may be derived from an epoxy-based compound.

In order to manufacture the tantalum capacitor 100 according to the embodiment, a pre-tantalum capacitor including the capacitor body 110 and the external electrodes 131 and 132 may be prepared.

The tantalum capacitor 100 may be manufactured by vacuum impregnating the pre-tantalum capacitor into at least one selected from the group consisting of an aminosilane-based compound, a silicone-based compound, and an epoxy-based compound. Through the vacuum impregnation, the interfacial compound may be filled in a region between respective components described above. Accordingly, penetration of moisture through the inter-region is suppressed, thereby reducing corrosion and opening defects and improving reliability.

The aminosilane-based compound may include 3-aminopropyltrimethoxysilane (APTMS) and 3-aminopropyltriethoxysilane (APTES). These may be used alone or in combination of two or more.

The silicone-based compound may include KJF-810 from Shin-Etsu Silicone Co., Ltd.

The epoxy-based compound may include a bisphenol A type epoxy resin, a novolac type epoxy resin, and the like. These may be used alone or in combination of two or more.

In some embodiments, the capacitor body 110 may further include a substrate layer 114 positioned below the capsule portion 113. For example, a bottom surface of the substrate layer 114 may be provided as the sixth surface of the capacitor body 110.

The substrate layer 114 may support a combination of the tantalum body 111, the tantalum wire 112, and the capsule portion 113. Accordingly, structural stability of the tantalum capacitor 100 may be further improved.

The substrate layer 114 may include an insulating material such as a curable resin and an inorganic filler. These may be used alone or in combination of two or more.

The curable resin may include a cresol novolac epoxy resin, a bisphenol A type epoxy resin, a bisphenol A type novolac epoxy resin, a phenol novolac epoxy resin, a multifunctional epoxy resin, a biphenyl type epoxy resin, a xylene type epoxy resin, a triphenol methane type epoxy resin, an alkyl modified triphenol methane epoxy resin, a naphthalene type epoxy resin, a dicyclopentadiene type epoxy resin, a dicyclopentadiene modified phenol type epoxy resin, and the like. These may be used alone or in combination of two or more.

The inorganic filler may include silica (SiO₂), alumina (Al₂O₃), silicon carbide (SiC), barium sulfate (BaSO₄), talc, clay, mica powder, aluminum hydroxide (Al(OH)), magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃), and calcium zirconate (CaZrO₃). These may be used alone or in combination of two or more. The strength of the substrate layer 114 may be improved and the thickness thereof may be reduced through the inorganic filler.

In some embodiments, the capacitor body 110 may further include a lower electrode 115 positioned between the substrate layer 114 and the tantalum body 111. The lower electrode 115 may include a metal such as copper (Cu) and nickel (Ni).

One end of the lower electrode 115 may contact the second surface of the capacitor body 110 to be electrically connected to the second external electrode 132. Through the lower electrode 115, the second external electrode 132 may be electrically connected to the cathode components (for example, the solid electrolyte layer, the cathode reinforcing layer, and the like) of the tantalum capacitor 100.

The above-described interfacial compound may be positioned in at least one of regions between the tantalum wire 112 and the capsule portion 113, between the external electrodes 131 and 132 and the capsule portion 113, and between the lower electrode 115 and the substrate layer 114. The region between the lower electrode 115 and the substrate layer 114 may include the region between the capsule portion 113 and the substrate layer 114. Through the interfacial compound, moisture penetration and corrosion between the lower electrode 115 and the substrate layer 114 may be prevented. Accordingly, durability and reliability of the tantalum capacitor 100 may be further improved.

The presence of the above-described interfacial compound may be measured by Fourier Transform Infrared (FT-IR) analysis or Raman spectrum analysis. A cross-section (L-T cross-section) cut in the length direction (L-axis direction) and the stacking direction (T-axis direction) perpendicular to the width direction from the center of the width direction (W-axis direction) of the tantalum capacitor 100 may be exposed. The exposure may be performed by polishing with a polishing machine. In the L-T cross section, 10 points spaced at uniform intervals may be set between the tantalum wire 112 and the capsule portion 113 (region B of FIG. 2), between the external electrodes 131 and 132 and the capsule portion 113 (region A of FIG. 2), or between the lower electrode 115 and the substrate layer 114 (region C of FIG. 2). The presence of chemical bonds may be measured by performing FT-IR analysis or Raman spectral analysis on the points. When a C—H bond and a Si—C bond are detected together, it may be evaluated as a compound including the C—H bond and the Si—C bond. When a Si—O—Si bond is detected, it may be evaluated as a compound including the Si—O—Si bond. When a C—O bond is detected, it may be evaluated as a compound including the C—O bond. When the chemical bond is detected at five or more of the ten points, it may be evaluated that the interfacial compound is present.

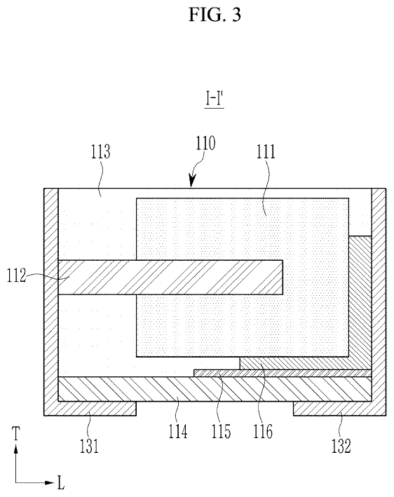

FIG. 3 illustrates a cross-sectional other of a tantalum capacitor according to another embodiment taken along line I-I′ of FIG. 1.

Referring to FIG. 3, the capacitor body 110 may further include a conductive bonding layer 116 positioned between the tantalum body 111 and the external electrodes 131 and 132, and between the tantalum body 111 and the lower electrode 115. Accordingly, the bonding strength of the tantalum body 111, the lower electrode 115, and the second external electrode 132 may be improved, thereby further improving structural stability and operating reliability.

The conductive bonding layer 116 may include a conductive bonding agent including an epoxy-based resin or a conductive metal powder (for example, silver (Ag)).

Hereinafter, specific examples of the present disclosure will be described. The examples described below are

### Example 1

A tantalum capacitor having the structures shown in FIG. 1 and FIG. 2 was manufactured.

Specifically, tantalum powder that was first granulated as tantalum powder and camphor as a binder were mixed, and a tantalum wire was inserted into the mixture, and the mixture was formed into a rectangular parallelepiped shape and sintered to manufacture a tantalum body having a tantalum wire inserted therein.

A Cu-plated lower electrode was bonded to a first surface of the substrate layer (FR4 substrate). A pre-tantalum capacitor including a capsule portion was manufactured by fixing the bottom surface of the tantalum body and the lower electrode so as to be in contact, and molding EMC on the substrate layer to cover the tantalum body, the tantalum wire, and the lower electrode. The FR4 substrate may be interpreted in the sense generally used in the art. For example, the FR4 substrate represents an insulating material having a structure in which multiple layers of glass fibers impregnated with epoxy resin are laminated.

The pre-tantalum capacitor was vacuum-impregnated into 3-aminopropyltrimethoxysilane (APTMS) to manufacture a tantalum capacitor including an interfacial compound.

### Example 2

A tantalum capacitor was manufactured in the same manner as in Example 1, except that the pre-tantalum capacitor was vacuum-impregnated with KJF-810 from Shin-Etsu Silicon Co., Ltd. instead of APTMS.

### Example 3

A tantalum capacitor was manufactured in the same manner as in Example 1, except that the pre-tantalum capacitor was vacuum-impregnated with bisphenol A type epoxy resin instead of APTMS.

### Comparative Example

A tantalum capacitor was manufactured in the same manner as in Example 1, except that the pre-tantalum capacitor was used as the final tantalum capacitor without performing the vacuum impregnation.

### Evaluation 1: FT-IR Analysis

The periphery of the tantalum capacitors of the above-described examples and comparative examples was fixed with an epoxy resin.

The tantalum capacitor was polished using a polisher so that a cross-section (L-T cross-section) cut in the length direction (L-axis direction) and the stacking direction (T-axis direction) perpendicular to the width direction from the center of the width direction (W-axis direction) of the tantalum capacitor was exposed.

FT-IR analysis was performed on 10 points in each region of the L-T cross section: between the external electrode and the capsule portion (region A of FIG. 2), between the tantalum wire and the capsule portion (region B of FIG. 2), and between the lower electrode and the substrate layer (region C of FIG. 3). Whether i) C—H bond and Si—C bond ii) Si—O—Si bonds or iii) C—O bond were detected at the 10 points was analyzed, and if the i), the ii), or the iii) bonds were detected at five or more points, it was evaluated that the interfacial compound was present. If the i), the ii), or the iii) bonds detected at less than 5 points (including 0), it was evaluated that no interfacial compound existed.

The FT-IR analysis was performed using a Nicolet iN10 Infrared Microscope from Thermo Fisher Scientific under the following conditions: spectral range of 650 cm⁻¹ to 4000 cm⁻¹, Reflectance mode, MCT detector, resolution of 8 cm⁻¹, and accumulation of 64.

The evaluation results are shown in Table 1 below. In Table 1, “∘” means that an interfacial compound exists, and “X” means that an interfacial compound does not exist. In Table 1, “-” means that no chemical bond is detected.

TABLE 1

| | Whether | Detection |
|---|---|---|
| | detected | chemical |
| | or not | bond |
| Example 1 | ◯ | C—H, Si—C |
| Example 2 | ◯ | Si—O—Si |
| Example 3 | ◯ | C—O |
| Comparative | X | — |
| example | | |

The presence or absence of chemical bond may be detected by performing Raman spectrum analysis instead of the FT-IR analysis on the same points as the measurement points. Regarding the detection result, whether or not the interfacial compound is detected may be evaluated in the same manner as FT-IR.

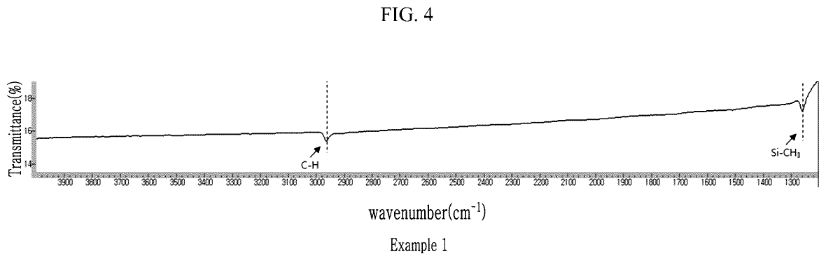

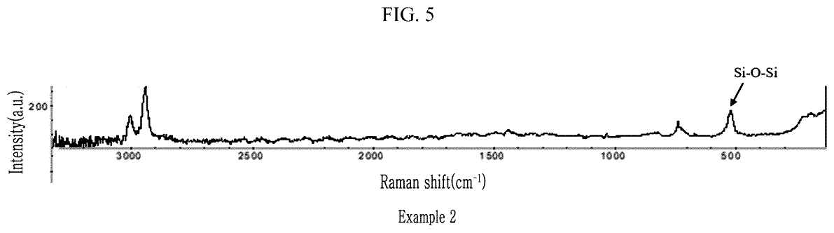

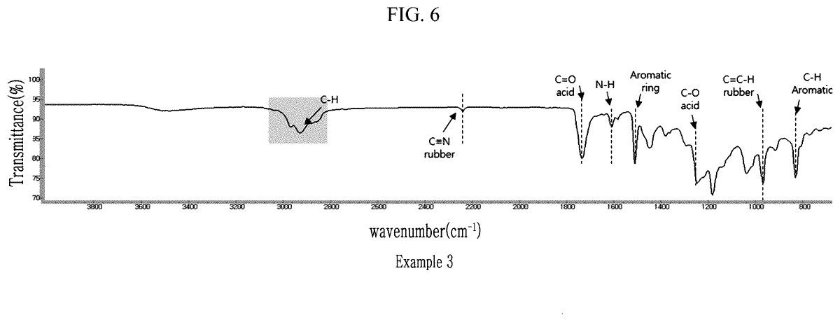

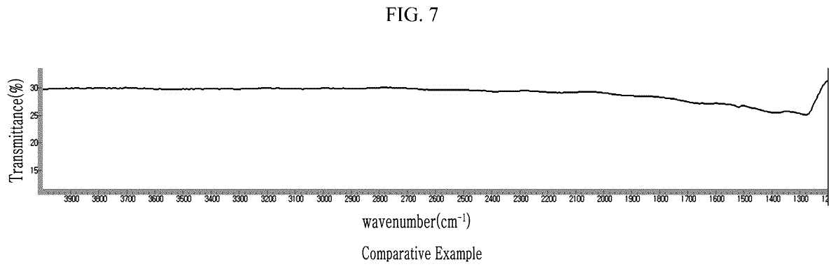

FIG. 4, FIG. 6, and FIG. 7 illustrate FT-IR analysis graphs of Example 1, Example 3, and the comparative example, respectively. FIG. 5 illustrates a Raman spectrum analysis graph of Example 2.

Referring to FIG. 4 to FIG. 7, in Example 1, an interfacial compound including both a C—H bond and a Si—C bond was detected, in Example 2, an interfacial compound including a Si—O—Si bond was detected, and in Example 3, an interfacial compound including a C—O bond was detected.

In the comparative example, no interfacial compound was detected between the external electrode and the capsule portion (region A of FIG. 2), between the tantalum wire and the capsule portion (region B of FIG. 2), and between the lower electrode and the substrate layer (region C of FIG. 3).

### Evaluation 2: Highly Accelerated Stress Test (HAST)

A highly accelerated temperature and humidity stress test (HAST) was performed on the tantalum capacitors of Example 1 and the comparative example described above.

Specifically, 40 tantalum capacitors were prepared, and the normal implementation of capacitance for each tantalum capacitor was evaluated for 50 hours in an environment of 115° C., 95% relative humidity, and 1 VR rated voltage. It was defined as a defect that the capacitance was not normally implemented, and the time until the defect occurred was measured.

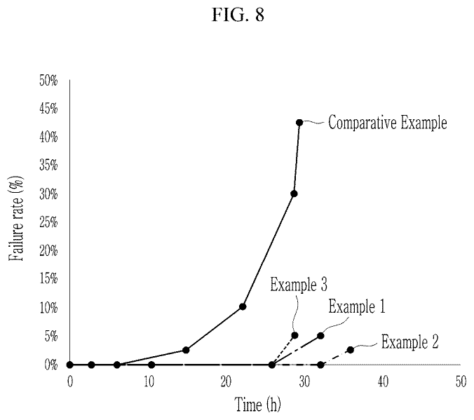

The failure rate was evaluated by expressing the ratio of the number of tantalum capacitors in which the defects occurred among the total number of 40 tantalum capacitors as a percentage. The failure rate according to evaluation time is shown in FIG. 8.

FIG. 8 illustrates a graph of results of a high-acceleration stress test (HAST) of each of the tantalum capacitors of Example 1 and the comparative example.

Referring to FIG. 8, in Example 1, moisture penetration between the external electrode and the capsule portion (region A of FIG. 2), between the tantalum wire and the capsule portion (region B of FIG. 2), and between the lower electrode and the substrate layer (region C of FIG. 3) was suppressed through the interfacial compound, so that opening defects were relatively suppressed and reliability and stability were improved compared to the comparative example.

What is claimed is:

1. A tantalum capacitor comprising:
a capacitor body including a tantalum body, a tantalum wire connected to the tantalum body, and a capsule portion surrounding the tantalum body and the tantalum wire; and
an external electrode positioned outside the capacitor body,
wherein one or both of: (a) a region between the tantalum wire and the capsule portion, and (b) a region between the external electrode and the capsule portion, comprises an interfacial compound including at least one selected from the group consisting of: (i) a compound including a C—H bond and a Si—C bond, (ii) a compound including a Si—O—Si bond, and (iii) a compound including a C—O bond.

2. The tantalum capacitor of claim 1, wherein
the capacitor body further includes a substrate layer positioned below the capsule portion, and a lower electrode positioned between the substrate layer and the tantalum body.

3. The tantalum capacitor of claim 2, wherein
a region between the lower electrode and the substrate layer includes the interfacial compound.

4. The tantalum capacitor of claim 2, wherein
the capacitor body further includes a conductive bonding layer between the tantalum body and the external electrode and between the tantalum body and the lower electrode.

5. The tantalum capacitor of claim 1, wherein
the compound including the C—H bond and the Si—C bond is derived from an aminosilane-based compound.

6. The tantalum capacitor of claim 1, wherein
the compound including the Si—O—Si bond is derived from a silicone-based compound.

7. The tantalum capacitor of claim 1, wherein
the compound including the C—O bond is derived from an epoxy-based compound.

8. The tantalum capacitor of claim 1, wherein
the capacitor body has first and second surfaces facing each other in a first direction, third and fourth surfaces facing each other in a second direction and connecting the first and second surfaces, and fifth and sixth surfaces facing each other in a third direction and connecting the first and second surfaces, and
the external electrode includes a first external electrode and a second external electrode respectively positioned on the first surface and the second surface.

9. The tantalum capacitor of claim 8, wherein
the first external electrode is connected to the tantalum wire.

10. The tantalum capacitor of claim 8, wherein
the capacitor body further includes a substrate layer positioned below the capsule portion, and a lower electrode positioned between the substrate layer and the tantalum body, and
the second external electrode is connected to the lower electrode.

11. The tantalum capacitor of claim 8, wherein
the first external electrode covers the first surface and at least a portion of the sixth surface together, and the second external electrode covers the second surface and at least a portion of the sixth surface together.

12. The tantalum capacitor of claim 1, wherein
the capsule portion includes an epoxy resin.

13. A method for manufacturing a tantalum capacitor, comprising:
preparing a pre-tantalum capacitor including a capacitor body and an external electrode positioned on a first surface of the capacitor body, the capacitor body comprising a tantalum body, a tantalum wire connected to the tantalum body, and a capsule portion surrounding the tantalum body and the tantalum wire; and
manufacturing a tantalum capacitor by vacuum impregnating the pre-tantalum capacitor into at least one selected from the group consisting of an aminosilane-based compound, a silicone-based compound, and an epoxy-based compound,
wherein one or both of: (a) a region between the tantalum wire and a capsule portion, and (b) a region between the external electrode and the capsule portion comprises an interfacial compound including at least one selected from the group consisting of: (i) a compound including a C—H bond and a Si—C bond, (ii) a compound including a Si—O—Si bond, and (iii) a compound including a C—O bond.

14. The method of claim 13, wherein the compound including the C—H bond and the Si—C bond is derived from an aminosilane-based compound.

15. The method of claim 13, wherein the compound including the Si—O—Si bond is derived from a silicone-based compound.

16. The method of claim 13, wherein the compound including the C—O bond is derived from an epoxy-based compound.
